(19) United States
(12) Patent Application Publication
(10) Pub. No.: US 2023/0148135 A1
(43) Pub. Date: May 11, 2023

(54) TRACKING USER AND OBJECT DYNAMICS USING A COMPUTERIZED DEVICE

(71) Applicant: AGT INTERNATIONAL GMBH, Zurich (CH)

(72) Inventors: Omair GHORI, Darmstadt (DE); Michael LEIGSNERING, Muhltal (DE); Grigory ALEXANDROVICH, Niestetal (DE); Saad JAVED, Darmstadt (DE); Markus SCHLATTMANN, Griesheim (DE); Robert BIEHL, Darmstadt (DE)

(21) Appl. No.: 17/904,843

(22) PCT Filed: Dec. 14, 2020
(86) PCT No.: PCT/IL2020/051285

§ 371 Date: Aug. 23, 2022

Related U.S. Application Data
(60) Provisional application No. 62/980,493, filed on Feb. 24, 2020.

(51) Int. Cl. G06T 7/20; G06V 20/40; G06V 40/20

(52) U.S. Cl. CPC G06T 7/20; G06V 20/41; G06V 40/23; G06T 2207/20081

(57) ABSTRACT

The presently disclosed subject matter includes a computerized system and method of tracking and characterizing dynamics using at least one ML model configured to operate well under conditions where data input rate is varying as well as condition where data input rate is constant.

### FIELD OF THE PRESENTLY DISCLOSED SUBJECT MATTER

The presently disclosed subject matter is related to the field of machine learning and user-computer interaction.

### BACKGROUND

Today some computer-implemented applications are designed to identify and monitor interactions of a user with physical elements located in the real-world environment, as well as virtually generated elements. For example, some smartphone-implemented applications are designed to make use of their camera and processing capabilities to monitor interactions of a user with physical objects (e.g. a ball) located in the surrounding environment, and provide some kind of feedback with respect to a user's performance when doing so.

### GENERAL DESCRIPTION

Examples of the presently disclosed subject matter include a system and related methods which are aimed in general at tracking dynamics (motion) of users and and/or objects in a monitored environment. This includes, but is not limited to: user activity, including user interaction with the environment (e.g. walking, running, jumping, etc.) and user interactions with other items in the environment (e.g. ball, stick, racket, heavy bag, etc.); dynamics of objects and their interaction with the environment (e.g. ball rolling or bouncing on the ground, etc.); and interaction of one object with another (e.g. two balls hitting, ball being hit by a racket, ball bouncing against a wall, etc.). User activity includes in some examples complex exercises comprising a sequence of interactions with one or more objects in the environment (e.g., balls juggling, bouncing a ball on various body parts, ball dribbling, hitting a tennis ball with a racket against a wall, punching a heavy bag, etc.). Notably, for simplicity the term “object” is used herein collectively to refer to both animate (e.g. person, animal) and inanimate objects (e.g. ball, heavy bag, bat, etc.). It is noted that, for simplicity in the following description, the term “dynamic(s)” is used as a general term broadly referring to any type of motion of users and objects, and should not be construed as limited to any specific type of motion. It is further noted that the term “interaction” is used herein to include a mutual or reciprocal action or dynamics occurring between two or more elements in the environment.

As mentioned above, tracking dynamics is performed by a computerized device, such as a smartphone or laptop computer. Sensors of the computerized device (e.g., camera, IMU, GPS, audio) and optionally other auxiliary devices (e.g. an IMU on a smart watch), as well as inter device communication (e.g. ultrawideband precise localization), are used to capture the environment and relevant objects located therein; the captured images and/or other sensed data is then processed to determine the relative spatial configuration of the environment, user and objects.

The terms “activity world” or “environment” as used herein refer in general to an area in which dynamics are taking place and being monitored. In some examples, the computerized device can be used for creating the activity world as a virtual environment that corresponds to the real world physical environment, mapping the dynamics in the physical world to the virtual environment, and tracking the dynamics. In some examples, the activity world may, additionally or alternatively, refer to augmented reality where digitally generated interactive virtual elements are blended into the real-world physical environment.

The computerized device may be further configured to provide feedback to the user in real-time (or near real-time), during and after execution of user activity. Feedback can be for example acoustic or visual, and can be related in some cases to guidance regarding the setup of the system, guidance regarding execution of the activity, feedback regarding user performance, etc.

Systems and methods disclosed herein are designed for the purpose of determining detailed information about dynamics including user activity. As further explained below, this information includes for example: a type of action being exercised, a type of interaction that is currently being exercised, the specific body part of the user that has interacted with an object, the type of the object, the state of the object and user at the time of interaction (e.g. static or mobile, ball is rolling, bouncing, in air, etc.), the time stamp of the action/interaction, etc. According to some examples, as part of the process that is executed for obtaining this information, one or more machine learning (ML) models are applied on a stream of sensed data (e.g. images) recorded during user activity, in order to detect and classify dynamics of user and objects.

Different types of computerized devices (e.g. Smartphones) are often characterized by differences in performance related for example to their respective computational and heat constraints. These technical differences affect the processing capability of the device. In addition, differences in performance may also exist in devices of the same type operating under different conditions (e.g. when running other programs in parallel, or when operating with low battery).

Specifically, variations in device performance (which are sometimes unstable and erratic) may influence signal processing of input data received from various sensors, including for example processing of: captured images, recorded voice or sound in general, acceleration, velocity, etc. These variations cause further variations in input rate of the data which is being fed to the ML model. For example, in case of captured image input, variation may include variations in the number of image samples provided per second, where one type of smartphone may be able to provide processing input to a ML model at a rate of 30 frames per second (fps), and another type of smartphone (or the same smartphone operating at different times and/or under different conditions) may be limited to an input rate of 25 fps. These differences in performance may therefore cause poor quality of the ML model output and ultimately result in poor detection, classification and tracking of dynamics (e.g. user activity).

According to some examples, the presently disclosed subject matter is aimed at providing robust and accurate detection, classification and tracking of dynamics in an input stream of sensed data. This goal is achieved by using ML models which are specifically configured to operate well under conditions where data input rate is varying as well as condition where data input rate is constant.

According to one aspect of the presently disclosed subject matter there is provided a computerized method of tracking and characterizing dynamics using at least one ML model, the method comprising operating at least one processing circuitry for:

obtaining an input data stream, the input data stream comprising sensed data of dynamics of one or more elements in an environment;

assigning a fixed temporal input grid defining a respective input rate of input data samples to the at least one ML model;

processing the input data stream and generating a corresponding stream of data samples in which one or more elements are identified;

applying the at least one ML model on the stream of data samples for classifying dynamics of the one or more elements;

the classifying including:

upon detection of a gap of missing data, the gap comprising one or more points along the fixed temporal grid which lack respective data samples in the stream of data samples, inferring the missing data based on information that includes data gathered based on the temporal input grid, giving rise to inferred data;

characterizing an interaction of the one or more elements based on the stream of data samples and the inferred data.

In addition to the above features, the method according to this aspect of the presently disclosed subject matter can optionally comprise one or more of features (i) to (xxiii) below, in any technically possible combination or permutation.

(i) Wherein the one or more elements include a user, and the dynamics include user dynamics recorded during an activity of the user in the environment; wherein the interaction is interaction of the user with an object or with the environment during the activity.

(ii) Wherein determining the inferred data is based on information that includes: the input rate of the fixed temporal input grid and available data samples preceding and/or following the gap.

(iii) The method further comprising applying one or more detection ML models on the input data stream dedicated to identifying the one or more elements.

(iv) The method further comprising using the one or more ML models for determining a respective position of each of the one or more elements in the environment.

(v) Wherein the input data stream is an input image stream and the data samples are image data samples.

(vi) Wherein each image data sample is generated from a respective frame in the input image stream and comprises data including: 2D and/or 3D positioning data of the one or more elements.

(vii) Wherein the input data stream is any one of:
input stream of acceleration measurements; input audio stream; and input stream of velocity measurements; and
wherein the data samples are any one of:
acceleration data samples; audio data samples; and velocity data samples, respectively.

(viii) Wherein the characterizing includes determining a state of the one or more elements, the state being indicative of a specific type of interaction.

(ix) Wherein the characterizing includes determining a specific body part of the user being in contact with the object.

(x) Wherein the characterizing includes determining a specific part of a body part being in contact with the object.

(xi) The method further comprising: determining a plurality of events based on data samples in the stream of data samples; wherein a duration of an event is shorter than a duration of a state; and wherein the determining of the state is based on the plurality of events.

(xii) Wherein determining an event of the plurality of events further comprises:
detecting a plurality of event candidates within a sliding window applied on the stream of data samples;
calculating a value of a certainty of detection for each event candidate;
selecting from the plurality of event candidates an event having a highest value.

(xiii) The method further comprising:
creating a lag in the processing of data samples in the stream of data samples input thus creating a delay in processing output of the at least one ML model;
processing additional data samples for the duration of the delay;
determining later events based on the additional data samples, wherein the determining of the state is based on the plurality of events and the later events.

(xiv) The method further comprising:
determining one or more interaction events based on data samples in the stream of data samples;
wherein the determining of a given event comprises:
identifying a suspected interaction event based on a plurality of data samples;
creating a lag in the processing of data samples in the stream of data samples input thus creating delay in processing output of the at least one ML model;
processing additional data samples received during the delay and following the suspected interaction event;
validating the suspected interaction event based on the additional data samples.

(xv) Wherein inferring the missing data comprises one or more of:
a. extrapolating the missing data based on one or more data samples preceding the gap; and
b. interpolating the missing data based on one or more data samples preceding the gap, and one or data samples following the gap.

(xvi) Wherein inferring the missing data comprises determining a speed and/or a trajectory of the one or more elements in the input data stream, and using the determined speed and/or trajectory for inferring the missing data.

(xvii) Wherein the trajectory is determined by selecting a motion model having a best fit to a motion pattern of the element, the motion model mathematically representing the motion pattern.

(xviii) The method further comprising determining a sequence of interactions and determining an activity based on the sequence of interaction.

(xix) The method further comprising:
determining a sequence of states and events and applying computer logic dedicated to characterizing the activity based on the sequence of states and events.

(xx) The method further comprising,
operating in real-time, while an activity is taking place, at least one sensor for obtaining the input data stream.

(xxi) Wherein the input data stream is a video stream, the method further comprising operating at least one camera operatively connected to the processing circuitry for continuously capturing the video stream.

(xxii) The method further comprising generating feedback with respect to the activity; and displaying the feedback on a display screen operatively connected to the at least one processing circuitry.

(xxiii) The method further comprising, during a training phase, dedicated to training the at least one ML model:
adapting the input rate of the stream of data samples to a rate that is different than the respective input rate defined by the fixed temporal grid, thereby resulting in at least one gap of missing data corresponding to one or more data samples, the gap emulating an input data stream having varying input rate;
and providing the stream of data samples to the at least one ML model, at the adapted input rate to thereby enable training of the ML model to operate in real-time conditions where the input data stream is characterized by a varying input rate.

According to another aspect of the presently disclosed subject matter there is provided a non-transitory computer readable storage medium tangibly embodying a program of instructions that, when executed by a computer, cause the computer to perform the method according method specified above.

According to another aspect of the presently disclosed subject matter there is provided a system of tracking and characterizing dynamics, the system comprising at least one processing circuitry configured to:

obtain an input data stream, the input data stream comprising sensed data of dynamics of one or more elements in an environment;

assign a fixed temporal input grid defining a respective input rate of input data samples to at least one ML model;

process the input data stream and generating a corresponding stream of data samples in which one or more elements are identified;

apply the at least one ML model on the stream of data samples for classifying dynamics of the one or more elements;

the classifying including:

upon detection of a gap of missing data, the gap comprising one or more points along the fixed temporal grid which lack respective data samples in the stream of data samples, infer the missing data based on information that includes data gathered from the temporal input grid, giving rise to inferred data;

characterize an interaction of the one or more elements based on the stream of data samples and the inferred data.

The computerized methods, the system and the non-transitory computer readable storage media disclosed herein according to various aspects, can optionally further comprise one or more of features (i) to (xxiii) listed above, mutatis mutandis, in any technically possible combination or permutation.

According to another aspect of the presently disclosed subject matter there is provided a computerized method of training a machine learning model dedicated to classifying dynamics of one or more objects, the method comprising using at least one processing circuitry for:

obtaining an input data stream, the input data stream comprising sensed data of dynamics of one or more objects in an environment;

assigning a fixed temporal input grid defining a respective input rate of input data samples to the at least one ML model;

adapting the input rate of the stream of data samples to a rate that is different to the respective input rate defined by the fixed temporal grid, thereby resulting in at least one gap of missing data corresponding to one or more data samples, the gap emulating an input data stream having varying input rate;

providing the stream of data samples to the at least one ML model, at the adapted input rate, to thereby train the at least one ML model, upon detection of a gap of missing data comprising one or more points along the fixed temporal grid which lack respective data samples in the stream of data samples, to infer the missing data in real-time conditions where the input data stream is characterized by a varying input rate.

The presently disclosed subject matter further contemplates a computer system comprising at least one processing circuitry configured to execute the method according to the previous aspect.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a high-level schematic block-diagram illustration of a computerized system, according to some examples of the presently disclosed subject matter;

FIG. 2a is a schematic block-diagram illustration of a computer processing circuitry configured according to some examples of the presently disclosed subject matter;

FIG. 2b is a schematic block-diagram illustration of a machine learning execution module, according to some examples of the presently disclosed subject matter;

FIG. 2c is a schematic block-diagram illustration of a machine training module, according to examples of the presently disclosed subject matter;

FIG. 3 is a generalized flowchart showing a sequence of operations carried out, according to some examples of the presently disclosed subject matter;

FIG. 4 is a flowchart showing a sequence of operations carried out during training of the machine learning models, according to some examples of the presently disclosed subject matter;

FIG. 5 is a flowchart showing operations carried out during detection and classification by the machine learning modules, according to some examples of the presently disclosed subject matter; and

FIG. 6 is another flowchart showing operations carried out during detection and classification by the machine learning modules, according to some examples of the presently disclosed subject matter.

### DETAILED DESCRIPTION

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Unless specifically stated otherwise, as apparent from the following discussions, it is appreciated that throughout the specification discussions utilizing terms such as “assigning”, “obtaining”, “processing”, “classifying”, “applying”, “characterizing”, “inferring” or the like, include actions and/or processes of a computer that manipulate and/or transform data into other data, said data represented as physical quantities, e.g. such as electronic quantities, and/or said data representing the physical objects.

The terms “computer”, “computer/computerized device, “computer/computerized system”, or the like, as disclosed herein should be broadly construed to include any kind of hardware-based electronic device with a data processing circuitry (e.g. digital signal processor (DSP), a GPU, a TPU, a field programmable gate array (FPGA), an application specific integrated circuit (ASIC), microcontroller, microprocessor etc.). The processing circuitry can comprise for example, one or more computer processors operatively connected to computer memory, loaded with executable instructions for executing operations, as further described below.

The computerized device, according to examples of the presently disclosed subject matter, also comprises one or more sensors, including, in some examples, but not limited to, an image acquisition device (e.g. camera), as further described below. An example of a computerized device includes a smartphone and a laptop computer. Notably, in the following description, the term “smartphone” is sometimes used as an example of a computerized device and should not be construed to limit the principles of the disclosed subject matter to smartphones alone.

In the following description various examples are provided with respect to an image data stream, where image data samples are processed, however this is done by way of example only. It is noted that the presently disclosed subject matter is not limited to the processing of image data alone and provides a general solution that can be likewise applied in the processing of other types of streams of data samples characterized by varying rates, including for example, audio data, acceleration data, communication data, etc.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

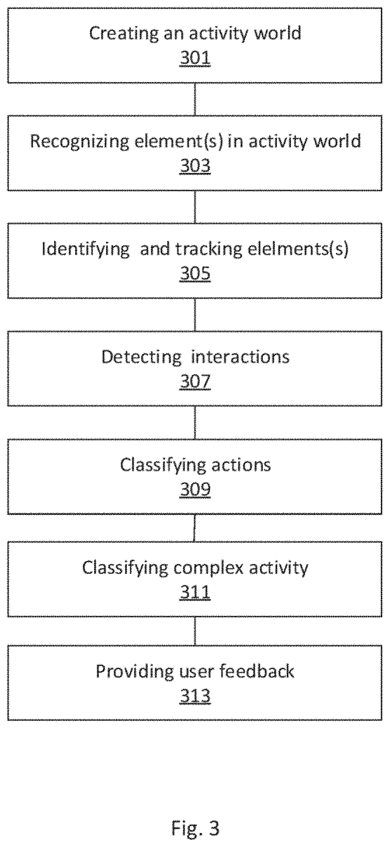

In embodiments of the presently disclosed subject matter, fewer, more and/or different stages than those shown in FIGS. 3-6 may be executed. In embodiments of the presently disclosed subject matter, one or more stages illustrated in FIGS. 3-6 may be executed in a different order and/or one or more groups of stages may be executed simultaneously.

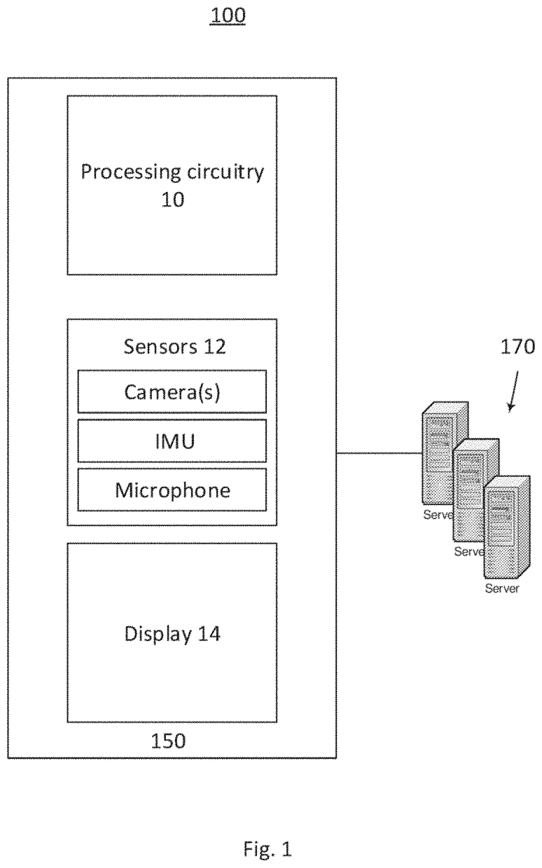

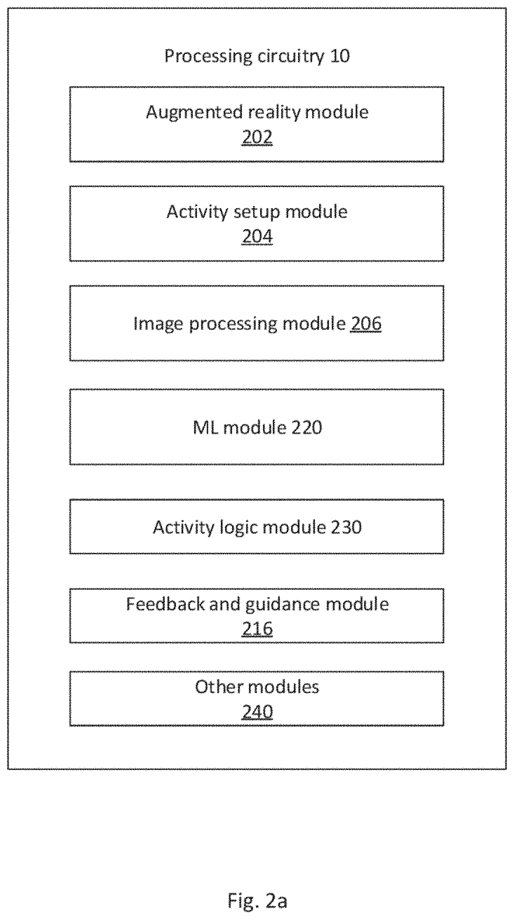

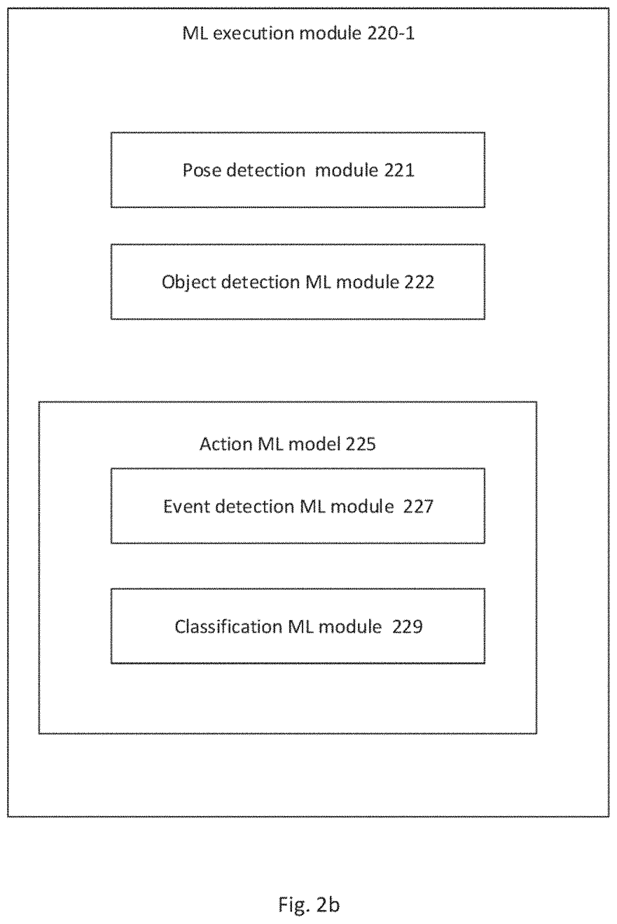

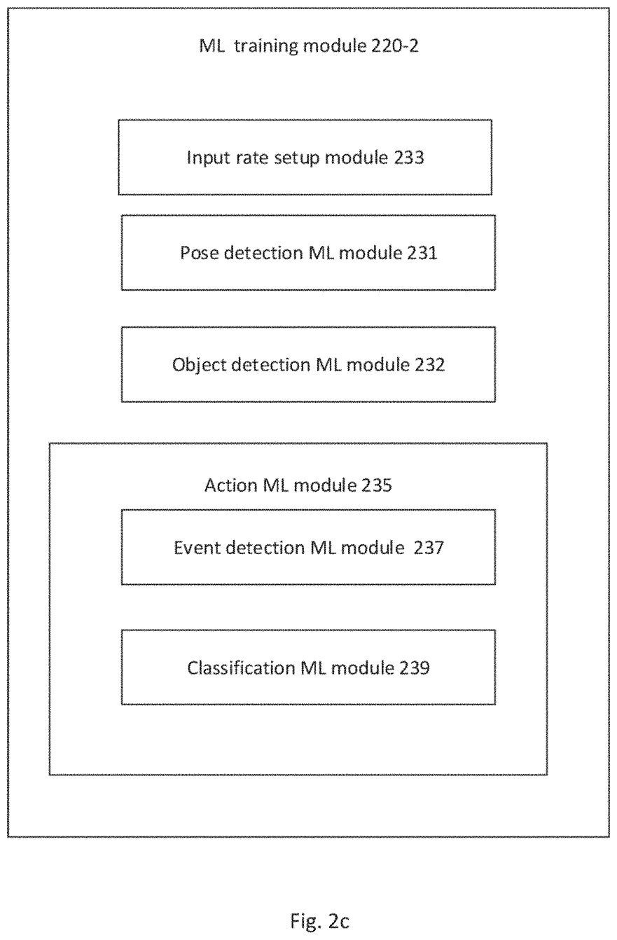

FIGS. 1, 2a, 2b and 2c illustrate various aspects of the system architecture in accordance with some examples of the presently disclosed subject matter. Elements in FIGS. 1, 2a, 2b and 2c can be made up of a combination of software and hardware and/or firmware that performs the functions as defined and explained herein. Elements in FIGS. 1, 2a, 2b and 2c may be centralized in one location or dispersed over more than one location. In other examples of the presently disclosed subject matter, the system may comprise fewer, more, and/or different elements than those shown in FIGS. 1, 2a, 2b and 2c.

Bearing the above in mind, attention is drawn to FIG. 1, which is a high-level schematic block-diagram illustration of a computerized system according to examples of the presently disclosed subject matter. As shown, the computerized system 100 comprises at least one computerized device 150 (e.g. user end device), which comprises in turn, processing circuitry 10 operatively connected to one or more sensors 12, and to a display device 14. The sensors can comprise for example one or more of the following: one or more cameras, one or more accelerometers, one or more gyroscopes, one or more microphones, etc. Sensors 12 can include an IMU (Inertial Measurement Unit) that comprises the accelerometers, gyroscopes and possibly also one or more magnetometers.

Processing circuitry 10 is configured to provide the processing necessary for executing operations as further disclosed herein below. The processing circuitry 10 comprises or is otherwise operatively connected to one or more computer processors and can also comprise computer memory (which are not shown separately). The processor(s) of processing circuitry 10 can be configured to execute one or more functional modules in accordance with computer-readable instructions implemented on a non-transitory computer-readable memory comprised in the processing circuitry. Such functional module(s) are referred to hereinafter as comprised in the processing circuitry. User end device 150 can be for example a smartphone or laptop computer which comprises the necessary hardware and software components.

In some examples, system 100 includes one or more computerized devices 170 (e.g. one or more remote computer server devices) in addition to the user end device 150, where some of the operations disclosed herein (including for example the ML training process) are executed on these devices rather than on the user end device. According to this example, training of the machine learning model is executed on one or more computerized devices (e.g. on the cloud) and the trained model is provided to end device 150 where the model is used for tracking in real-time dynamics occurring in the activity world including user activity.

FIG. 2a is a schematic block-diagram showing some components of processing circuitry 10, according to some examples of the presently disclosed subject matter. Notably, the division of the functionality into the specific modules as shown is done by way of example and for ease of understanding only, and should not be construed as limiting in any way.

In some examples components of processing circuitry 10 includes:
Augmented reality module 202 is configured to generate an activity world. In general, generation of an activity world can be accomplished based on data obtained from the various onboard sensors, including, for example, imaging data captured by the one or more cameras. Processing circuitry 10 can be configured to recognize certain features in the captured image which are suitable as placeholders for tracing relative position of objects from one image to the next along a sequence of captured images e.g. in a video stream. Based on the phone's known camera parameters (e.g. camera orientation, position, focal length, distortion, etc.) which can be obtained from its sensors, such features can be used for 2D and/or a 3D (e.g. partial 3D) reconstruction of the scene (e.g. generating a ground plane representing the physical ground or floor) and simultaneous localization of the phone inside this virtual 3D reconstruction. In some cases, the phone is moved during the 3D reconstruction of the environment to provide different viewing points. Methods technically disclosing the task of creating the activity world are well known in the art and include SLAM (Simultaneous Localization and Mapping) methods.
Activity (e.g. exercise) setup module 204 is configured to execute methods of setting up an exercise or physical task to be performed by a user. In some examples, this module is responsible for providing instructions to the user during a scanning phase in which the user is guided to move the phone in a certain way in order to enable generation of the activity world by augmented reality module 202. In some examples, this module is configured to generate and display on the display device a graphical user interface for user interaction, for example, to enable user interaction with the device for selecting desired activity parameters and/or placing virtual elements inside the virtual representation of the physical world, etc.
Image analysis (processing) module 206 is configured to execute various methods (including computer vision methods) of implementing image processing on captured images for the purpose of recognizing, detecting and/or tracking relevant elements in the physical environment and to facilitate mapping of physical objects to physical representation in the virtual environment. Image analysis includes for example, analysis of articulated objects in 2D or 3D (e.g. humans). One example of an image analysis module task is initial recognition of the existence of objects and users in the environment (activity world). Another more specific example, is detection of ball bounding boxes in the image stream, i.e. the area (sizes) and position of pixels in the image that correspond to the real world position of the ball in different frames along a sequence of frames. According to some examples, execution of operations by image analysis module 206 may include implementing an appropriate machine learning model. For example, ML can be implemented for identifying users and/or the type of the object (e.g. ball, bat, goal, etc.) in the captured images.

In some examples, image analysis can be combined with the operation of augmented reality module 202 to determine location and orientation of objects within the virtual environment created by module 202.

According to the presently disclosed subject matter, machine learning (ML) algorithms (also referred to as “models”) are used for the purpose of detection and classification of dynamics recorded by sensors (including images captured by the image sensors of a computer system) within an activity world. According to more specific examples, and as further explained below, a machine learning model is trained in order to detect events and states describing dynamics of users and objects that enables the activity logic module 230 to determine specific interactions and activities within the activity world.
To this end, the processing circuitry may comprise ML module 220, configured to execute a machine learning process that includes one or more machine learning models. A schematic illustration of a machine learning execution module 220-1 is shown in FIG. 2b. The trained machine learning process can be executed in real-time by machine learning execution module as described below.

As mentioned above, in some examples training of the machine learning model is executed on a computerized device different from end device 150. According to this example, at least one computerized device 170 (e.g. a server computer device) comprises a processing circuitry configured to execute the training process of training one or more machine learning models for the purpose of detection and classification of dynamics of users and objects. In general, the processing circuitry is configured to receive a training dataset that includes a stream of sensed data gathered by one or more sensors. Sensed data includes, but is not limited to, images showing various dynamics of users and objects, including scenarios of user activity, objects dynamics, various interactions of: user(s) with object(s), user(s) with the environment, object(s) with object(s), and object(s) with the environment. Other examples of sensed data include audio data, acceleration data (recorded for example by an accelerometer of a smartphone or accelerometer attached to the user's body or to the object), velocity, sound, etc.

According to some examples, the ML model is a supervised model where the training dataset is an annotated dataset. According to some examples, the machine learning models include deep learning models. A schematic illustration of a processing circuitry of a machine learning training module is shown in FIG. 2c. The ML models which are trained by the training module 220-2 are those which are executed in runtime by the ML execution module 220-1. For ease of understanding, modules which are shown in FIG. 2b have corresponding modules shown in FIG. 2c.

Following training, the trained machine learning models are provided to the end device where they can be used for monitoring dynamics (including user activity) in real-time. Furthermore, in some examples, processing circuitry 10 on end device 150 is configured to update the machine learning models based on the ML model output.
Feedback and guidance module 216 is configured to interact with a user and generate feedback for indicating various situations and guiding the user through the task. For example, generating a specific sound when the task is successful, and a different sound when the task is not successful.

In addition to the components described above, processing circuitry 10 can further comprise, or be otherwise operatively connected to, various additional modules (240). Some of these modules are described in further detail in PCT Application No. PCT/IL2020/050932, claiming priority from 62/891,515 to the Applicant, which is incorporated herein by reference in its entirety, and includes for example:
Multi-Target Tracking module (numbered 208 in PCT/IL2020/050932) configured to implement robust tracking of relevant objects over time in the stream of images. For example, in case multiple balls are visible within the image frame (detected for example by image analysis module 206) or other objects are falsely detected as balls, multi-target tracking supports separating between the different balls and assigning different detections and tracking of the respective trajectory of each physical ball, as well as detecting and ignoring the objects initially falsely detected as balls.
Tracking augmentation module(s) (numbered 210 in PCT/IL2020/050932) configured to apply various models for the purpose of increasing robustness of detection and tracking of relevant objects. The models include for example, motion models, appearance models, and object models. Multi-target tracking module 208 can be configured to utilize the functionality of tracking augmentation module(s) 210 during tracking of the one or more target objects detected in the environment.

Motion models are aimed at modelling the way objects are moving and predict future location of objects to improve object tracking. Associating between objects in different detections (images) helps to construct a continuous object trajectory for a given object over time.

Appearance models use appearance features (e.g. color, shape, texture) of objects detected in the scene for improving tracking. These features can be maintained for individual objects and assist in distinguishing between similarly looking objects (for example, objects of the same class e.g. different balls) and help to enable continuous tracking of the same object and construction of a continuous object trajectory over time. Appearance models are also suitable to re-detect the same object even if it has been completely lost (e.g. having disappeared from the field of view) or is being used in a completely new session (e.g. at the next day).

For example, in case a yellow ball and a red ball are identified in the scene, color-based appearance features can be well suited to support the assignment of detections of the current frame to detections of the previous frame, to thereby obtain a continuous assignment of the right trajectory of each ball from one frame to the next. In addition, if it is known that a specific user is using two balls with specific features, the balls can be re-detected in a different session on the next day. This might be specifically advantageous if the different balls have different physical properties (e.g. different dimensions, flight quality, etc.), which can serve as additional features for identifying each ball.
Object relevance determination module (numbered 212 in PCT/IL2020/050932) configured to classify identified objects as relevant and non-relevant objects based on various object characteristics such as for example their respective motion pattern or their respective location/orientation relative to other elements. For example, if several balls are present in the scene, a ball being kicked towards the goal is more relevant for a shot on goal exercise than a ball being stationary in the background. The object relevance determination module is configured to determine which ball is more relevant for the upcoming task. Object relevance determination module can also be used by multi-target tracking module to enhance tracking of objects. Thus, while multi-target tracking module is configured to track more than one target, object relevance determination module is configured to identify an object which is relevant to the activity.

FIG. 3 is a generalized flowchart showing a sequence of operations carried out according to some examples of the presently disclosed subject matter. Operations described with reference to FIG. 3 can be executed, for example, by computerized device 100 and more specifically one that comprises processing circuitry 10 with a ML module 220 as described above. However, it should be appreciated that while some operations are described with reference to processing circuitry 10, and its components, this is done by way of example only, and should not be construed to limit the operations to being implemented by a device having that specific design.

As mentioned above, operations disclosed herein below are aimed to provide robust and accurate detection and tracking of dynamics, including user activity (e.g. user interaction), in an activity world.

In some examples, an activity world may be created as an initial step (block 301). As mentioned above, the activity world can be for example, one or more of the following: an area defined in the physical environment where dynamics are monitored by the system; a virtual representation of a physical world; and an augmented reality world blending between a physical world and different virtual elements.

In some examples, during creation of the activity world the relevant area is scanned using at least one camera of the computerized device to thereby establish the activity world coordinate system. This can be accomplished for example with the help of augmented reality module 202. To this end a user can scan the surrounding area using various sensors (e.g. a video camera) in his smartphone and the location of the phone relative to the scanned environment is determined, in order to create an activity world with a consistent coordinate system, as is well known in the art. In some examples, a virtual ground plane representing the ground is determined based on recognizable features in the scanned environment. If the smartphone is moved, the mapping of the virtual world is continuously calculated to continuously maintain the position of the smartphone relative to the virtual world.

To enable monitoring and analysis of user activity or dynamics in general in real-time, during the entire period of the activity, one or more cameras (e.g. of the computerized device 150) are operated to continuously capture images of the activity world. The stream of images generated by the camera is processed in order to detect, classify and track an object's dynamics and/or user activity including interactions. In other examples, a previously recorded video stream of user activity can be also analyzed offline using the process described herein. As mentioned above, in addition, or instead, other types of data can be recorded during user activity, using appropriate sensors, and processed in a similar manner, e.g. audio data, acceleration, etc.

At blocks 303 and 305, the stream of captured images goes through a preliminary processing stage. During the preliminary processing stage relevant elements (the term “element” collectively referring to any one of: user(s), object (s) and the environment) within the stream of images are recognized (block 303), where “recognition” refers to generally detecting the presence of the elements. Elements in the activity world may include one or more physical and/or virtual items, where the user can interact with these items (e.g. a ball that can be thrown or kicked toward a target object such as a goal).

At block 305, following their recognition, different elements (e.g. user and object) located within the activity world are identified and tracked. This may include, in case of an object, identification of the type of a recognized object (e.g. ball, bat, goal, racket, etc.) and in case of a user, identifying various body parts of the user (e.g., the user's feet, hands, head, and various joints, such as elbows, knees, shoulders, etc.).

The output of the preliminary processing stage (referred to herein as “preliminary processing output”) includes, inter alio, information on elements identified in the stream of images such as: their type and sub-type (e.g. ball, bat, user and specific body part of the user), and their location (and possibly also their orientation) within the activity world.

In some examples, dedicated ML models are implemented for the purpose of executing the preliminary processing stage. For example, as further mentioned above, one ML model (pose ML detection model executed by pose detection ML module 221) is used for identifying a user as well as user body parts, and another ML model (object ML detection model executed by object detection ML module 222) is used for identifying objects.

In some examples, initial recognition and identification of a user and objects in the scene (activity world) can be executed with the help of image analysis module 206 and possibly also with object recognition module 212. According to this example, and different to that which is illustrated in FIGS. 2a and 2b, pose detection ML module 221 and object detection ML module 222 can be implemented as part of image analysis module 206.

Once recognized (and identified), the elements can be traced from one image to the next along the stream of images. In some examples, multi-target tracking module, and tracking augmentation module 210 can also be used for this purpose.

Dynamics of a user and an object (or possibly more than one user and/or more than one object) in the environment are tracked, and the position of the user and object, one relative to the other, is determined. Based on their relative position, interactions between them are detected (block 307). Interactions can be determined between a user and an object, a user and the environment (e.g. a ball bouncing on the ground), and between different objects (e.g. ball and bat).

According to some examples, once a user and/or object are identified and their relative position within the activity world is determined, dynamics of user and/or object is processed in further detail, in order to classify the specific type of actions and the manner in which the actions are being performed (block 309). This includes determination of specific actions, including interactions of the user or object with one another and/or with the environment, and more complex activities performed by the user. Examples of detailed information of user actions as disclosed herein, include the specific type of action or activity (e.g. with respect to a ball: holding ball, balancing ball, bouncing, etc.), the specific body part interacting with the object (e.g. head, right shoulder, left shoulder, right knee, left knee, right hand, left hand, etc.), the specific part of the body part that interacted with the object (e.g. front part of left foot (toes side) or back part of left foot (heel side), part of the hand (palm, fingers, back of hand), etc.) and the specific part of the object (e.g. specific part of a ball or bat, etc.).

According to some examples, a different ML model (action ML model executed by action ML module 225) is used for determining the detailed actions and interactions. According to examples of the presently disclosed subject matter, as part of the classification process mentioned above with respect to block 309, events and states, which are atomic components that are used for characterizing dynamics, are detected and classified as further explained below. In some examples, the action ML model is trained to detect events and states, which are combined for the detection of more complex activities comprised of a sequence of actions and/or interactions.

The term “state” as used herein includes information characterizing a prolonged condition or occurrence of an object or user in the activity world itself. In connection with an interaction of the user with an object, a state can refer to a specific manner of interaction, for example, object being held, object being balanced, object being bounced, etc. In connection with the environment, a state can refer to the specific dynamics of the object. For example, in case of a ball, whether the ball is rolling on the ground, bouncing on the ground, is static, in the air, undefined, etc. In case of a user, whether the user is walking, running, standing, jumping, etc.

The term “event” as used herein includes a generally short-lived (e.g. momentary) occurrence over a period shorter than that of a state, characterizing an object or user, relative to one another (interaction), or to the activity world itself. In one example, in a 60 frames per second video stream, an event can be defined as an occurrence extending 5 frames or less. For instance, during an activity that includes a ball being bounced by a user (defining a state) various events can be detected, including for example, the moment the ball leaves the hand of the user, the moment the ball hits the ground, the moment the ball is returned to the hand, etc. An event can also include the moment of transition from one activity (or state) to another. For example, a person starting to run after walking, or a person changing direction of advancement, ball bouncing after traveling through the air, etc.

As described in Patent Application PCT/IL2020/050932, according to some examples, a state of an object can be determined by fitting a motion model that mathematically describes the motion pattern (trajectory) of an object as well as the specific parameters defining the specific instance of the motion model. Image analysis is used for determining the motion pattern of an object or user, and a best fitting motion model is assigned according to the motion pattern. For example, different classes of motion models include those representing a parabola-like motion pattern (e.g. ball flying in the air), a straight-line motion pattern (e.g. ball rolling on the ground) and a fluctuating motion pattern (e.g. ball bouncing). Each specific motion pattern can be assigned to a specific motion model but is also characterized by specific parameters that differentiate between different states in the same class. Such parameters include height, speed, acceleration and direction vectors of the object.

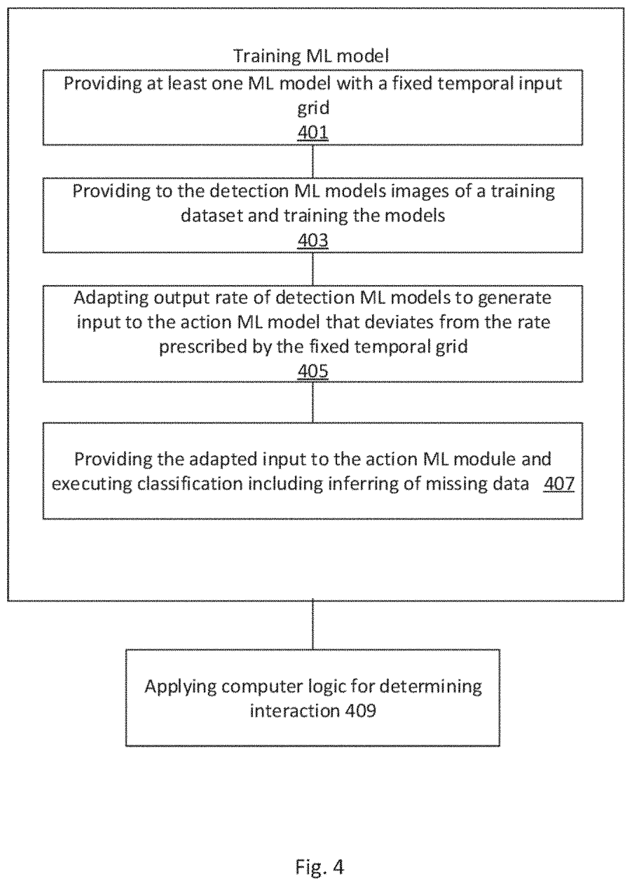

According to the presently disclosed subject matter, it is further disclosed to determine events and states using one or more machine learning models that are trained for this purpose. A more detailed description of various principles of the machine learning training process is described below with reference to FIGS. 4 to 6.

According to some examples, the output of the pose detection ML module 221 and the object detection ML module 222 (i.e. the preliminary processing output) is provided as input to an action ML module 225 configured to execute an action ML model, dedicated for determining states and events and classifying user activity. In some implementations action ML module 225 may be divided into an event detection ML module 227 configured to execute a ML model dedicated to detecting events, and classification ML module 229 configured to execute a ML model dedicated to classifying events and states.

In cases where both a motion model as described in PCT/IL2020/050932 and an ML model as described herein are available, their output can be combined. For example, the motion model can provide coarse detection of motion and the ML model can provide more accurate information characterizing the dynamics, thus increasing accuracy and robustness of the process.

In some examples, an event characterizing a certain interaction can be classified (e.g. by classification ML module 229) according to the specific body part with which the interaction occurred. For example, assuming a user is bouncing a ball on various body parts, events occurring during ball bouncing activity (e.g. an event of “moment of ball disconnecting from a body part”, or “moment ball is in contact with body part”) can be classified according to the specific body part with which the ball has been interacting (e.g. head, left foot, right foot, left shoulder, right shoulder, etc.).

Similarly, a state characterizing an interaction can be classified (e.g. by classification ML module 229) based on the specific body part with which the interaction occurred. For instance, assuming a user is interacting with a ball, any one of a number of possible states can be determined, including: holding the ball, balancing the ball, rolling the ball, etc., where the states can be further classified according to the specific body part with which the interaction occurred (e.g. head, hands, left foot, right foot, left shoulder, right shoulder, etc.).

Following classification of events and/or states, the classification output is further processed by computer logic (e.g. by activity logic module 230) that is configured to infer more complex activities based on the events and states (block 311). For example, as further demonstrated below, a repetitive sequence of states that include “ball in hand”, “ball on floor”, can be translated (depending also on other factors such as ball trajectory and speed) by the computer logic to ball dribbling activity. Additionally, or alternatively, a sequence of events can be translated to dribbling activity, e.g. ball released from hand, ball hits ground, ball bounces back, ball hits hand, etc.

In some examples, following detection and characterization of an activity, feedback is provided to the user (block 313). Providing feedback to the user can include, for example, analyzing the performance of the user to determine level of success of the activity, according to various performance metrics relevant for the exercise, such as speed of execution, accuracy of execution, number of successful repetitions, number of consecutive successful repetitions, etc. For example, in the ball juggling activity, the number of times the user has managed to juggle the balls in the air is determined and can be provided as feedback. In some examples, user feedback is provided on the display screen 14 of the computerized device 150.

Attention is now drawn to the flowchart in FIG. 4 showing operations related to the training process of the ML models, according to some examples of the presently disclosed subject matter. Training of the ML model takes place as a preliminary process before execution of the process of tracking and classification of dynamics described above with reference to FIG. 3. Operations described with reference to FIG. 4 can be executed for example by ML training module 220-2 illustrated in FIG. 2c.

At block 401 at least one ML model is set with a fixed temporal input grid defining a respective input rate of the data samples (e.g. image data sample), such that at each point in time along the grid, input data is expected to be received by the ML model. As further explained below, the fixed temporal grid ensures a fixed inner clock for the model, and thus enables inference of missing data, e.g. by extrapolation and/or interpolation. Notably, in some examples, the temporal input grid is configured with a resolution that is equal to or greater than the expected input rate of the image data samples. In such cases, each point along the grid receives either an input data sample, or, in case no sample is received, a null value.

According to some examples, the pose detection ML model and the object detection ML model (collectively referred to as “detection ML models”) are both characterized by an inherent constant input rate (e.g. 24 or 30 fps), while their output rate may be unstable and prone to variations. Delays and fluctuations in the raw data, received as output from the sensors, can result in missing data in the input provided to the detection ML models. Missing data can also be in the processing output of the detection ML models. In addition to being unstable (e.g. due to changes in overall processing intensiveness in the end device 150) there may also be differences between the output rate of the pose ML detection model and object ML detection model, e.g. in some cases the output rate of the pose ML model may be slower than the output rate of the object ML model, possibly resulting from differences in complexity of the processing of each model (the pose detection model, processing user motion, is generally more complex than the object detection model, processing object dynamics). Accordingly, inputs to the action model, provided by the pose detection ML model and the object detection ML model, may be characterized by varying and uneven rates.

According to the presently disclosed subject matter, to cope with variations in the input rate to the action ML model, the action ML model is assigned with a fixed input temporal grid, as mentioned above.

At block 403 image samples of a training dataset are continuously fed to the detection ML models. The training dataset comprises a plurality of images in a continuous video stream exhibiting dynamics in the activity world, including for example images captured during activity of the user (e.g. while interacting with an object). According to some examples, the training dataset is generated by capturing videos of a user interacting with an object in front of the camera, and assigning tags characterizing specific actions and interactions which are displayed in the images in the video. In some examples, tagging can be done automatically by a trained ML model. The training data set can include both positively tagged samples of interactions, showing interactions between user and object, and negatively tagged samples of interactions, showing failed interactions, e.g. juggling without a ball, only balls being juggled without a user, etc.

Data samples (e.g. images) from the training dataset are provided to the detection ML models which are trained to generate the preliminary processing output as described above with reference to blocks 303 and 305. The term “data sample” is used herein to include any type of data output of the preliminary processing. As explained above, with reference to FIG. 3, as part of the preliminary processing stage performed by the detection ML models, elements are recognized and identified, and their position and/or orientation in the activity world, as well as their relative 2D and/or 3D position and dynamics, are determined.

According to some examples, in case the data being processed is a stream of images (video), the preliminary processing output includes a stream of image data samples corresponding to the stream of frames. Generally, a corresponding output is generated for each image along an input video stream of the training set. In other examples, where other data is being processed, the preliminary processing output includes a stream of data samples of the respective data type (e.g. acceleration data sample, audio data sample, etc.). In some examples, a combination of different types of data samples can be processed.

According to some examples, neural network (NN) based ML models are used where the detection ML models include NN that outputs a value between 1 and 0 indicative of the certainty of detection. Only if the value is above a certain predefined threshold, detection is confirmed. According to other examples, other methods of identification can be used in addition to, or instead of, the detection ML models. For example, accelerometers fixed to an interacting body part of the user and to the object can be used for detection and tracking of the user and object.

According to some examples, various methods dedicated to enhancing the quality of the input data (e.g. image video stream) may be applied. For example, spatial normalization methods may be applied on the input image stream to account for different spatial configuration relative to the camera. Assuming for instance that the camera is not stationary, the position of the user relative to the image area may constantly change. Normalization helps to keep the user at the center of the activity world and represent the location of the object (e.g. ball) relative to the user. As user localization within images tends to be noisy, normalization further helps to reduce noise in the image data. According to one example, normalization is performed by dividing the pose coordinates of the user by the torso height (defined for example from shoulder to hips) to obtain a normalized height across different images. According to further examples, positional annealing methods (e.g. exponential smoothing) may also be applied to minimize noise due to spurious detection.

In some examples, annotation refinement is executed as well. As the training of the detection ML models evolves and becomes more accurate, the annotation of the training dataset can be compared to the output of the ML models. In case it is determined that there is a deviation that is smaller than a certain threshold (e.g. a distance smaller than N frames) between the timestamp of the original tagging and the timestamp of the actual detection of the ML model, the original tagging can be shifted according to the ML detection, thus helping to improve the tagging and obtain more accurate results during further training, and also to reduce noise and ultimately obtain a better model.

According to examples of the presently disclosed subject matter, as part of the training of the action ML model, the outputs of the detection ML models are adapted (e.g. by input setup module 233) to generate a stream of data samples to be used as input to the action ML model, where the stream of input is characterized by a rate that is different than the fixed input rate of the temporal input grid, such that time of input of data samples and time points along the input grid are at least partly asynchronous (block 405). This can be done for example, by selectively removing part of the data samples to artificially create gaps in the stream of data samples. Multiple gaps can be created in the stream of data samples, where different gaps have different lengths, thus emulating variations in the input rate. The lack of synchronicity results in points in time along the temporal grid, where the action ML model expects an input of image data samples from the detection ML models, but fails to receive the data. This serves to emulate varying input frequencies that may result from variations in performance of computerized devices, as discussed above.

According to one example, assuming the input rate prescribed by the grid is 60 fps, input setup module 233 may adapt the output of the detection ML models by removing some of the image data samples (by replacing the samples by some other neutral or null value, e.g. zeros) to create a stream of image data samples at a different rate, e.g. removing 3 of every 4 image data samples for obtaining a rate of 15 fps. Notably, output from different sources can be modified to have a different respective rate. For example, output of the pose detection ML module may be adapted to 15 fps, and output of the object detection module may be adapted to have 23 fps.

At block 407 the adapted output of the detection ML models is combined and used for the training of the action ML model. The action ML model is trained to classify dynamics of a user and/or objects in the environment. Classification includes characterization of specific interactions between a user (or a specific user's body part) and one or more objects. According to examples of the presently disclosed subject matter, classification includes detection of events and determination of states of a user (or user body part) and/or an object.

According to an example, the adapted output of the detection ML models is provided to the action ML model as input, which is configured in turn to determine whether input data (e.g. image data samples) is received for each given point along the assigned fixed input temporal grid, or whether a neutral value is received instead. In the following description the term “gap” is used to refer to one or more points along the fixed temporal grid which lack respective data samples (e.g. image data samples) in the stream of data samples. For instance, if a fixed input temporal grid has an input rate of 30 fps and the input data is received at a rate of 23 fps, a neutral value is assigned for each of the points along the grid where an input data is missing (representing a gap).

According to examples of the presently disclosed subject matter, the action ML model is further configured to complete missing image data samples. To this end the action ML module 225 is configured, upon detection of a gap representing one or more missing data samples (e.g. missing image data samples) at one or more points of time along a fixed temporal grid assigned to a certain ML model, to infer (e.g. extrapolate and/or interpolate) the missing data based on data samples received before the gap, and/or data samples received after the gap.

Since data is processed by the ML models according to a fixed temporal grid, missing data samples can be inferred from the existing data. As processing of data samples according to the temporal grid is done at constant repeating intervals, the time elapsed from the last available data sample is known, and the time that has passed since the last determination of an event or state can be determined as well. While the action ML model processes the stream of data samples for the purpose of detecting events and states, if one or more input data samples are missing, the ML model can still infer the event or state by interpolating and/or extrapolating the missing data, and then using the model to determine the state or event, based on the inferred data.

In some examples, inference of missing data is limited to gaps that are shorter than a certain predefined length (defined for example by time period or number of frames, e.g. shorter than 66.666 milliseconds, which normally equates to 4 frames i.e. 4 image data samples). In case a detected gap is greater than the predefined threshold, the inference of missing data samples is not performed, and, instead, the model waits until additional data samples are received.

For instance, given a video stream of images showing continuous interaction of a user with a ball, a gap of missing image data samples (e.g. caused for example from delayed input at the computerized device) can be extrapolated based on the processing output of the previously received image data samples and/or interpolated based on the processing output of image data samples received before and after the missing image samples.

Consider a specific example, in cases where an activity that is being tracked includes bouncing a ball on a user's knees, where the stream of image data samples includes a gap of a few missing image data samples. Assuming the processing preceding the gap shows that the ball has been bounced on the knee upwards, the (action) ML model can be trained to complete the missing data based on available information. For example, based on the ball trajectory in the upward direction and ball speed, determined from the available image data samples, it can be deduced that at the next point in time along the grid, following the last available image data sample, the ball is expected to commence movement in the opposite direction, i.e. downwards.

Likewise, in another example, when a ball is being dribbled, based on ball trajectory towards the ground and ball speed, which are determined based on the available image data samples, it can be determined that at the next point in time along the grid, following the last available image data sample, impact of the ball with the ground is expected.

Missing image data samples can also be inferred by interpolation based on images captured after a gap in the stream of image data samples. To this end, in some examples, once a gap is identified, detection and classification of events and states is delayed until more images are captured following the gap, and the image data samples extracted from these images (and possibly also image data samples preceding the gap) are used to infer the data missing in the gap.

To improve the accuracy and robustness of the action ML model output, the output can be enriched with information of object trajectories using its timestamp.

This information can be obtained for example from motion models as mentioned above. For example, motion model can assist in estimating the trajectory of an object for the purpose of inferring missing image samples of the ML model as explained above, where the timestamp enables to correctly match the motion model to the relevant gap of missing data samples.

Another method disclosed herein for improving accuracy and robustness of the ML models output includes the implementation of thresholding and/or peak detection. For example, event detection is examined relative to other detections of the same event within a certain predefined window (e.g. time window). The window can be defined for instance as a sliding window along the image data input stream that includes a certain number of frames preceding the event detection and a certain number of frames following the event detection. A plurality of detections of the same event (plurality of outputs of the event detection ML model, also referred to herein as “event candidates”) detected within the window, are compared, and the detection (event candidate) that has the highest value (certainty value), representing a peak of all candidate detections within the window, is selected.

As mentioned above, the output of the event detection model can include a value (e.g. score) that is indicative of the certainty of detection of an event (e.g. value between 1 and 0 in NN model). In some examples, all values, calculated within a predefined window that are above a first threshold value, are considered candidates for indicating the occurrence of an event. In case a certain (first) event detection value is above a second threshold value, greater than the first, the occurrence of an event is determined. Otherwise, consecutive image samples captured within the window are processed by the ML model to determine whether a stronger, i.e. having a higher score, indication of an event is found. If not, the first event detection value is considered valid, indicating an event. If so, the later and stronger indication is considered valid, and the first value is ignored.

As mentioned above at block 409, the states and events can be further processed using computer logic designed to determine the specific type of dynamics e.g. the type of activity that is being performed. In some examples, the computer logic is also adapted for providing feedback to the user.

Once the ML models have been trained to provide satisfactory outputs, they can be used for detection and tracking of dynamics in real-time.

It is noted that while training of the ML model is described above with reference to the specific example of detection and classification of user interaction with an object, this should not limit the scope of the specific ML training model to this specific purpose only, as the same principles of training, that include using a fixed temporal grid and inferring missing data, can be used for other purposes as well. For example, these principles can be implemented in a ML model dedicated to detecting and interpreting turn signals in a car, or traffic signals on the road. In the example of a car turn signal, the variations in input data can result from variations in the rate of image capture and/or variation in the frequency of the blinking of the turn light.

It is further noted that the ML model trained as disclosed herein to operate in conditions of varying input rate is also capable of operating effectively in conditions of constant input rate, e.g. where input data samples correlate with the input temporal grid.

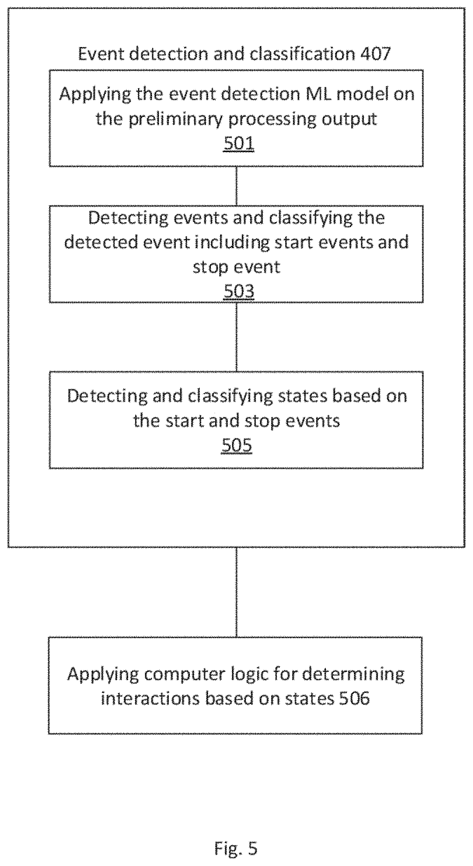

FIG. 5 is a flowchart showing an example of operations executed by the action ML model, according to some examples of the presently disclosed subject matter. Operations described with reference to FIG. 5 relate to classification of actions and activity.

Once a user and object(s) are recognized, and their relative position within the activity world is determined, at block 501 the action ML model is applied on the positioning data characterizing the elements within the activity world. In cases where identification and positioning of the elements is performed by detection of the ML models as explained above, the preliminary processing output of the detection models is provided as input to the action model. As mentioned above, the action ML model can be divided into an event detection and a classification ML model (implemented for example, by modules 227 and 229, respectively).

At block 503 events are detected and classified. The event detection ML model is trained to identify events, and the detected events are then classified by the classification ML model. For example, the moment of contact between a ball and hand or foot can be considered an event. Likewise, following a ball being held by a user, the moment the ball is released from the hand can also be considered an event.

Classification of an event includes characterizing a detected event. A supervised training data set can include, for example, a video stream of images showing various events which are annotated, the annotation enabling the action ML model to learn to associate between the relative positioning data of detected elements (e.g. position of ball relative to hand or ground) and the types of events. Once the model is trained, it can be used on raw data (non-annotated).

For instance, events can be classified according to whether there is contact (interaction) between a body part and an object. Contact between an object (e.g. ball) and a body part of a user can be classified for example as an ‘interaction event’. Otherwise, detection of the object and/or user without contact is classified as a ‘background event’. In another example, contact between the user or object and static environment can be classified as ‘interaction event with environment’ (e.g. ball with ground). In yet another example, contact between a first object and a second object can be classified as ‘interaction event object to object’ (e.g. first ball with a second ball).

As mentioned above, events can be further classified to provide more detailed information. For example, an ‘interaction event’ can be further classified according to the specific body part with which the interaction occurred (e.g. head, left or right hand, left or right foot, etc.). An ‘interaction event’ can be also classified according to the specific area of the interacting body part body part and/or the specific area of the interacting object, with which contact occurred. According to some examples, the detection of a specific body part, and/or a specific part thereof is performed by the pose detection ML model, the detection of a specific object and/or a specific part thereof is performed by the object detection ML model, and the action ML model is configured to combine the output of these two models and identify a specific interaction event based on their relative positions.

An interaction event may be further classified as a ‘start event’ or ‘stop event’. A ‘start event’ is identified when contact between the user and object is identified for the first time, when interaction begins. For example, if contact between the user's hand and a ball is detected for the first time (e.g. a first frame or sequence of frames in which such contact has been detected), such an ‘interaction event’ is classified as a ‘start event’. A ‘stop event’ is identified when previously identified contact between the user and the object stops. For example, assuming a ‘start event’ of a first contact has been identified, and a few frames later it is identified that the ball is no longer in contact with the user, a ‘stop event’ is identified.

In some examples, events are further classified, where, depending on the number of data samples (e.g. image data samples) between a start event and a stop event, it is further determined whether or not the event is an impulse event (a start event that is immediately followed by a stop event). If the number of frames is less than a certain threshold (e.g. 4 frames in a 60 fps video stream), the sequence of frames is determined as an impulse event i.e. a short lived event indicating some abrupt change in the user or object. For example, a ball that hits the user's hand and bounces right back.

At block 505 in case the number of data samples (e.g. image data samples) between the start and stop events exceeds the threshold, a state is determined and classified by classification ML model based on the classified events. For example, a sequence of frames starting from a ‘start event’, followed by several consecutive frames classified to the same category which are followed by a ‘stop event’, are classified as a certain state.

Thus, according to this approach, detected events are classified as start events and stop events and the classified events are used by the ML model to classify states occurring between the start and stop events. As explained in more detail above, during classification of events missing data samples are inferred by extrapolation and/or interpolating based on the available data, thereby enabling detection and classification of events and states in conditions of varying input.

The following is a specific example of classification processes according to FIG. 5:

1. Detection of imaged data (of at least one corresponding frame) showing initial contact between ball and user hand (as seen in a certain frame) is classified as {‘interaction event’, ‘start event’, ‘ball in hand’};

2. The first event is followed by N frames, which are processed to output additional classification for each frame {‘interaction event’, ball in hand};

3. Detection of image data (of at least one corresponding frame) showing no more contact between the ball and user and ball in air, is classified as {‘stop event’, ‘background event’, ball in air};

In some examples, in cases where the number of frames detected between a start event and a stop event is greater than a certain predefined value, the above sequence of events can be classified as a “ball holding” state. Otherwise, in cases where the number of frames detected between the start event and stop event is less than a certain predefined value, the above sequence of events, being a momentary event, can be classified as a “ball bounce off hand” impulse event.

At block 506, the output of the action model can be further processed by computer logic (e.g. by activity logic 230) dedicated to inferring more complex activity from the classified states and events. For example, if the above sequence of events is repeated, i.e. ball is being repeatedly thrown to the air and caught by the user, a “ball throwing activity” is identified.

As demonstrated above, classification of events and states is based on events detected overtime. Accordingly, in some examples the processing output of the action ML model is intentionally delayed, thus creating a lag (delay) in the processing of data samples in the input stream of data samples, for the purpose of gathering more information on data samples during the duration of the delay, in order to improve accuracy and robustness of detection and classification of events and states and avoid mistakes in the classification. In one non-limiting example, the applied delay can be between 80 and 100 milliseconds, derived based on a selected number of samples and the temporal grid sample input rate.

For example, in cases where classification of a state is dependent on the sequence of events starting with a start event and ending with a stop event, the classification output of the ML model (start event) is delayed in order to obtain additional (future) data samples, detect later events (e.g. stop event) based on the additional data samples, and use these events during classification of the state.

Giving a more specific example, in case of a ball bouncing on the ground, the falling ball will quicky change direction upwards after hitting the ground or some other object. By delaying the processing, the events of the ball hitting the ground and changing direction to leave the ground can be identified and used for providing a better classification of both the events preceding the gap (ball falling to the ground and hitting the ground) as well as the entire activity (ball bouncing on the ground).

Giving another example, in case a ball flying in the air is identified in a 2D image sample input, at the moment the ball passes another object, two different occurrences are possible:

1. ball passing the object and continues to advance along its original trajectory—no event is recorded.

2. ball hits object and bounces or stops—an event is recorded.

At the moment the ball and object intersect it is not possible to determine which occurrence will immediately follow. Thus, according to some examples, initially a suspected interaction event is determined (e.g. interception of one object with another identified based on 2D image data samples). However, the processing output indicting an event is delayed and not provided immediately. Rather, during the delay more data samples that follow the occurrence of the suspected event are gathered and used for validating (substantiating or refuting) the occurrence of the event. Accurate determination of events provides a more accurate determination of states and activities as well.

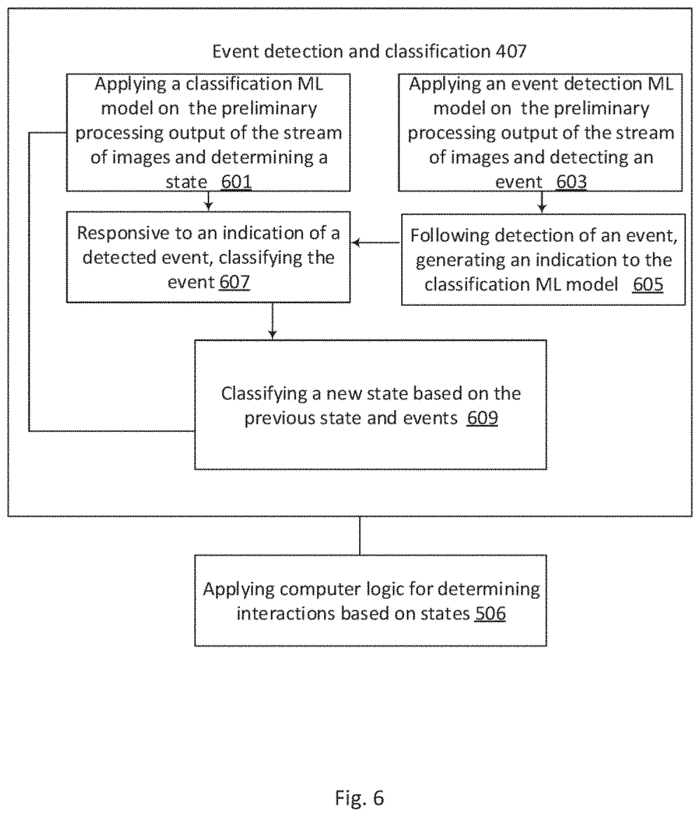

FIG. 6 is a flowchart showing another example of operations executed by the action ML models, according to some examples of the presently disclosed subject matter.

At block 601 a classification ML is applied on the preliminary processing output. Each image data sample is classified, and a respective state is determined based on the classification. For example, classification can include assigning image data samples to a background class or contact class, where background classification is assigned to image data samples that do not show contact between user and object, and contact classification is assigned to image data samples that show contact between user and object. Classification can further include additional details of the interaction, including, for example, which elements are interacting (e.g. user with object, object with ground, object with object, etc.), the specific body part or part of the object, the specific pose of the user, etc.

At block 603 events are detected by the event detection model in a process that is executed in parallel to the classification process mentioned above with respect to block 601. According to this approach, an event is detected only when a change occurs to a user and/or an object, e.g. in response to a sudden change in the ball trajectory or change in contact between ball and user. Once an event is detected, the event detection ML model generates an indication, informing the classification ML model that an event has been detected i.e. transition from being in background class to contact class, or vice versa. At block 607, responsive to detection of an event, the classification ML model classifies the event, and, following the classification, a change in the state is determined, based on classification of the event (block 609).

The following is an example of classification according to FIG. 6:

1. An object in a first frame is classified to “contact” class and a state is determined accordingly, {class: contact, state: ball in hand};

2. A sequence of N frames, following the first frame, do not exhibit an event and classification of state remains, {class: contact, state: ball in hand};

3. Transition from “contact” class to “background” class is determined (the ball leaves the hand), and an event is detected;

4. The event is classified and a change in state is determined {class: background, state: ball in air};

5. Transition from “background” class to “contact” class is determined (the ball returns to hand), and an event is detected;

6. The event is classified and a change in state is determined {‘class: contact’; state: ball in hand};

Like block 506 above at block 606, the output of the action model can be further processed by computer logic (e.g. by activity logic 230) dedicated to inferring more complex activity from the classified states and events. For example, if the above sequence of events is repeated, i.e. ball is being repeatedly thrown to the air and caught by the user, a “ball throwing activity” is identified.

The presently disclosed subject matter further contemplates user interaction in an augmented reality. Augmented reality includes the blending of interactive virtual, digitally generated elements, into real-world environments. Virtual elements include, for example, visual overlays, haptic feedback, or other sensory projections. For instance, some smartphone-implemented augmented reality applications allow users to view the world around them through their smartphone cameras, while projecting items, including onscreen icons, virtual game parts and game items (e.g. virtual goal), creatures, scores, etc., as overlays, make them seem as if these items are real-world items. It is noted that the term “object” as used herein should be broadly construed to include both a physical object and a virtually generated object.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a computer-readable non-transitory memory tangibly embodying a program of instructions executable by the computer for performing the method of the presently disclosed subject matter. The term “non-transitory” is used herein to exclude transitory, propagating signals, but to otherwise include any volatile or non-volatile computer memory technology suitable to the application.

It is also to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A computer implemented method of tracking and characterizing dynamics using at least one ML model, the method comprising operating at least one processing circuitry for:
obtaining an input data stream, the input data stream comprising sensed data of dynamics of one or more elements in an environment;
assigning a fixed temporal input grid defining a respective input rate of input data samples to the at least one ML model;
processing the input data stream and generating a corresponding stream of data samples in which one or more elements are identified;
applying the at least one ML model on the stream of data samples for classifying dynamics of the one or more elements;
the classifying including:
upon detection of a gap of missing data, the gap comprising one or more points along the fixed temporal grid which lack respective data samples in the stream of data samples, inferring the missing data based on information that includes data gathered based on the temporal input grid, giving rise to inferred data;
characterizing an interaction of the one or more elements based on the stream of data samples and the inferred data.

2. The method of claim 1, wherein the one or more elements include a user, and the dynamics include user dynamics recorded during an activity of the user in the environment; wherein the interaction is interaction of the user with an object or with the environment during the activity.

3. The method of any one of claims 1 and 2, wherein determining the inferred data is based on information that includes: the input rate of the fixed temporal input grid and available data samples preceding and/or following the gap.

4. The method of any one of the preceding claims, further comprising: applying one or more detection ML models on the input data stream dedicated to identifying the one or more elements.

5. The method of claim 4 further comprising using the one or more ML models for determining a respective position of each of the one or more elements in the environment.

6. The method of any one of the preceding claims, wherein the input data stream is an input image stream and the data samples are image data samples.

7. The method of claim 6, wherein each image data sample is generated from a respective frame in the input image stream and comprises data including: 2D and/or 3D positioning data of the one or more elements.

8. The method of any one of the preceding claims, wherein the input data stream is any one of:
input stream of acceleration measurements; input audio stream; and input stream of velocity measurements; and
wherein the data samples are any one of:
acceleration data samples; audio data samples; and velocity data samples, respectively.

9. The method of any one of the preceding claims, wherein the characterizing includes determining a state of the one or more elements, the state being indicative of a specific type of interaction.

10. The method of any one of claims 2 to 9, wherein the characterizing includes determining a specific body part of the user being in contact with the object.

11. The method of claim 10, wherein the characterizing includes determining a specific part of a body part being in contact with the object.

12. The method of any one of claims 9 to 11 further comprising: determining a plurality of events based on data samples in the stream of data samples; wherein a duration of an event is shorter than a duration of a state; and wherein the determining of the state is based on the plurality of events.

13. The method of claim 12, wherein determining an event of the plurality of events further comprises:
detecting a plurality of event candidates within a sliding window applied on the stream of data samples;
calculating a value of a certainty of detection for each event candidate;
selecting from the plurality of event candidates an event having a highest value.

14. The method of claim 12 further comprising:
creating a lag in the processing of data samples in the stream of data samples input thus creating a delay in processing output of the at least one ML model;
processing additional data samples for the duration of the delay;
determining later events based on the additional data samples, wherein the determining of the state is based on the plurality of events and the later events.

15. The method of any one of claims 1 to 8 further comprising:
determining one or more interaction events based on data samples in the stream of data samples;
wherein the determining of a given event comprises:
identifying a suspected interaction event based on a plurality of data samples;
creating a delay in processing output of the at least one ML model;
processing additional data samples received during the delay and following the candidate event;
validating the candidate interaction event based on the additional data samples.

16. The method according to any one of the preceding claims, wherein inferring the missing data comprises one or more of:
c. extrapolating the missing data based on one or more data samples preceding the gap; and
d. interpolating the missing data based on one or more data samples preceding the gap, and one or data samples following the gap.

17. The method of any one of any one of the preceding claims, wherein inferring the missing data comprises determining a speed and/or a trajectory of the one or more elements in the input data stream, and using the determined speed and/or trajectory for inferring the missing data.

18. The method of claim 17, wherein the trajectory is determined by selecting a motion model having a best fit to a motion pattern of the element, the motion model mathematically representing the motion pattern.

19. The method of any one of the preceding claims, further comprising:
determining a sequence of interactions and determining an activity based on the sequence of interaction.

20. The method of any one of claims 13 to 19 further comprising:
determining a sequence of states and events and applying computer logic dedicated to characterizing the activity based on the sequence of states and events.

21. The method of any one of the preceding claims, further comprising, operating in real-time, while an activity is taking place, at least one sensor for obtaining the input data stream.

22. The method of any one of the preceding claims, wherein the input data stream is a video stream, the method further comprising operating at least one camera operatively connected to the processing circuitry for continuously capturing the video stream.

23. The method of any one of the preceding claims further comprising: generating feedback with respect to the activity; and displaying the feedback on a display screen operatively connected to the at least one processing circuitry.

24. The method of claims 1 to 20 further comprising, during a training phase, dedicated to training the at least one ML model:
adapting the input rate of the stream of data samples to a rate that is different than the respective input rate defined by the fixed temporal grid, thereby resulting in at least one gap of missing data corresponding to one or more data samples, the gap emulating an input data stream having varying input rate;
and providing the stream of data samples to the at least one ML model, at the adapted input rate to thereby enable training of the ML model to operate in real-time conditions where the input data stream is characterized by a varying input rate.

25. A system of tracking and characterizing dynamics, the system comprising at least one processing circuitry configured to:
obtain an input data stream, the input data stream comprising sensed data of dynamics of one or more elements in an environment;
assign a fixed temporal input grid defining a respective input rate of input data samples to at least one ML model;
process the input data stream and generating a corresponding stream of data samples in which one or more elements are identified;
apply the at least one ML model on the stream of data samples for classifying dynamics of the one or more elements;
the classifying including:
upon detection of a gap of missing data, the gap comprising one or more points along the fixed temporal grid which lack respective data samples in the stream of data samples, infer the missing data based on information that includes data gathered from the temporal input grid, giving rise to inferred data;
characterize an interaction of the one or more elements based on the stream of data samples and the inferred data.

26. The system of claim 25, wherein the one or more elements include a user, and the dynamics include user dynamics recorded during an activity of the user in the environment; wherein the interaction is interaction of the user with an object or with the environment during the activity.

27. The system of any one of claims 25 and 26, wherein determining the inferred data is based on information that includes: the input rate of the fixed temporal input grid and available data samples preceding and/or following the gap.

28. The system of any one of claims 25 to 27, wherein the at least one processing circuitry is further configured to apply one or more detection ML models on the input data stream dedicated to identifying the one or more elements.

29. The system of claim 28 wherein the at least one processing circuitry is further configured to use the one or more ML models for determining a respective position of each of the one or more elements in the environment.

30. The system of any one of claims 25 to 29, wherein the input data stream is an input image stream and the data samples are image data samples.

31. The system of claim 30, wherein each image data sample is generated from a respective frame in the input image stream and comprises data including: 2D and/or 3D positioning data of the one or more elements.

32. The system of any one of claims 25 to 31, wherein the input data stream is any one of:
input stream of acceleration measurements; input audio stream; and input stream of velocity measurements; and
wherein the data samples are any one of:
acceleration data samples; audio data samples; and velocity data samples, respectively.

33. The system of any one of claims 25 to 32, wherein the at least one processing circuitry is configured for characterizing an interaction of the one or more elements to determine a state of the one or more elements, the state being indicative of a specific type of interaction.

34. The system of any one of claims 26 to 33, wherein the at least one processing circuitry is configured for characterizing an interaction of the one or more elements to determine a specific body part of the user being in contact with the object.

35. The system of claim 34, wherein the at least one processing circuitry is configured for characterizing an interaction of the one or more elements to determine a specific part of a body part being in contact with the object.

36. The system of any one of claims 33 to 35, where the at least one processing circuitry is configured to determine a plurality of events; wherein a duration of an event is shorter than a duration of a state; and wherein the determining of the state is also based on the plurality of events.

37. The system of claim 36, wherein the processing circuitry is further configured for determining an event of the plurality of events to:
detect a plurality of event candidates within a sliding window applied on the stream of data samples;
calculate a value of a certainty of detection for each event candidate;
select from the plurality of event candidates an event having a highest value.

38. The system of any one of claims 25 to 37, wherein the processing circuitry is further configured to:
create a delay processing output of the at least one ML model;
process additional data samples for the duration of the delay;
determine later events based on the additional data samples, wherein the determining of the state is based on the plurality of events and the later events.

39. The method of any one of claims 25 to 32, wherein the processing circuitry is further configured to:
determine one or more interaction events based on data samples in the stream of data samples;
wherein the determining of a given event comprises:
identify a suspected interaction event based on a plurality of data samples;
create a delay in processing output of the at least one ML model;
process additional data samples received during the delay and following the candidate event;
validate the suspected interaction event based on the addition data samples.

40. The system of any one of claims 25 to 39, wherein the processing circuitry is configured for inferring the missing data to perform one or more of:
a) extrapolate the missing data based on one or more data samples preceding the gap; and
b) interpolate the missing data based on one or more data samples preceding the gap, and one or data samples following the gap.

41. The system of any one of claims 25 to 40, wherein the processing circuitry is configured for inferring the missing data to:
determine a speed and/or a trajectory of the one or more elements in the input data stream and inferring the missing data based on the speed and/or trajectory.

42. The system of claim 41, wherein the at least one processing circuitry is configured for determining the trajectory to select a motion model having a best fit to a motion pattern of the element, the motion model mathematically representing the motion pattern.

43. The system of any one of claims 25 to 42, wherein the at least one processing circuitry is further configured to determine a sequence of interactions and determining an activity based on the sequence of interactions.

44. The system of any one of claims 33 to 43, wherein the at least one processing circuitry is further configured to:
determine a sequence of states and events and applying computer logic dedicated to characterizing the activity based on the sequence of states and events.

45. The system of any one of claims 25 to 44, wherein the at least one processing circuitry is further configured, during an execution stage, to operate in real-time, while an activity is taking place, at least one sensor for obtaining the input data stream.

46. The system of any one of claims 25 to 45 further comprising at least one camera operatively connected to the at least one processing circuitry, wherein the input data stream is a video stream, the at least one camera is configured to continuously capture the video stream.

47. The system of any one of claims 25 to 46, wherein the at least one processing circuitry is further configured to generate feedback with respect to the activity; and displaying the feedback on a display screen operatively connected to the at least one processing circuitry.

48. The system of any one of claims 25 to 47, wherein the at least one processing circuitry is further configured, during a training phase, dedicated to training the at least one ML model, to:
adapt the input rate of the stream of data samples to a rate that is different than the respective input rate defined by the fixed temporal grid, thereby resulting in at least one gap of missing data corresponding to one or more data samples, the gap emulating an input data stream having varying input rate;
and provide the stream of data samples to the at least one ML model, at the adapted input rate to thereby enable training of the ML model to operate in real-time conditions where the input data stream is characterized by a varying input rate.

49. A non-transitory computer readable storage medium tangibly embodying a program of instructions that, when executed by a computer, cause the computer to perform the method according to any one of claims 1 to 24.

50. A portable computerized device comprising at least one processing circuitry configured to:
obtain an input data stream, the input data stream comprising sensed data of dynamics of one or more elements in an environment;
assign a fixed temporal input grid defining a respective input rate of input data samples to at least one ML model;
process the input data stream and generating a corresponding stream of data samples in which one or more elements are identified;
apply the at least one ML model on the stream of data samples for classifying dynamics of the one or more elements;
the classifying including:
upon detection of a gap of missing data, the gap comprising one or more points along the fixed temporal grid which lack respective data samples in the stream of data samples, infer the missing data based on information that includes data gathered from the temporal input grid, giving rise to inferred data;
characterize an interaction of the one or more elements based on the stream of data samples and the inferred data.

51. The portable computerized device of claim 51 is a smartphone.

52. A computerized method of training a machine learning model dedicated to classifying dynamics of one or more objects, the method comprising using at least one processing circuitry for:
obtaining an input data stream, the input data stream comprising sensed data of dynamics of one or more objects in an environment;
assigning a fixed temporal input grid defining a respective input rate of input data samples to the at least one ML model;
adapting the input rate of the stream of data samples to a rate that is different to the respective input rate defined by the fixed temporal grid, thereby resulting in at least one gap of missing data corresponding to one or more data samples, the gap emulating an input data stream having varying input rate;
providing the stream of data samples to the at least one ML model, at the adapted input rate, to thereby train the at least one ML model, upon detection of a gap of missing data comprising one or more points along the fixed temporal grid which lack respective data samples in the stream of data samples, to infer the missing data in real-time conditions where the input data stream is characterized by a varying input rate.

53. The computerized method according to claim 52, wherein inferring the missing data comprises one or more of:
a. extrapolating the missing data based on one or more data samples preceding the gap; and
b. interpolating the missing data based on one or more data samples preceding the gap and one or data samples following the gap.
